(19) United States
(12) Patent Application Publication
(10) Pub. No.: US 2016/0313835 A1
(43) Pub. Date: Oct. 27, 2016

(54) ON-SCREEN DISPLAY ADJUSTMENT SYSTEM AND METHOD

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: XI-HUAI HE, Wuhan (CN); CHUN-SHENG CHEN, New Taipei (TW)

(21) Appl. No.: 14/721,669

(22) Filed: May 26, 2015

(30) Foreign Application Priority Data
Apr. 27, 2015 (CN) 201510203946.2

(51) Int. Cl. G06F 3/041; G06F 3/0484; G09G 5/00; G06F 3/0489; G09G 3/20; G06F 3/0482; G06F 3/0488; G09G 5/30

(52) U.S. Cl. CPC G06F 3/0412; G06F 3/04883; G06F 3/04847; G09G 5/30; G06F 3/0489; G09G 3/2096; G06F 3/0482; G09G 5/003; G06F 3/0416; G09G 2354/00; G09G 2320/0606; G09G 2320/08

(57) ABSTRACT

An on-screen display (OSD) adjustment system includes a display module, a control module, a touch module, and a switch module. The control module controls the display module to display multimedia files. The switch module includes a first switch unit coupled between the control module and the touch module and a second switch unit which is coupled between the touch module and a host. The control module determines whether user adjustment of the OSD is required and if so switches on the first switch unit and switches off the second switch unit. The touch module is electronically coupled to the control module, such that the control module is capable of receiving operation signals by touching on the touch module, to adjust configurable items of the monitor. An OSD adjustment method is further disclosed.

### FIELD

The subject matter herein generally relates to on-screen displays.

### BACKGROUND

A number of buttons, for adjusting configurations of a monitor, are generally attached to a bottom frame or a side frame of the monitor. The configurable items are brightness, saturability, contrast, and so on. When the configurations need to be adjusted, a menu button is pressed to show an on-screen display (OSD) window, then other buttons, such as up button and down button, can be pressed to adjust the configurable items.

### BRIEF DESCRIPTION OF THE DRAWINGS

Implementations of the present technology will now be described, by way of example only, with reference to the attached figures.

FIG. 1 is a block diagram of an embodiment of an on-screen display adjustment system and a host.

FIG. 2 is another block diagram of the on-screen display adjustment system and the host of FIG. 1.

FIG. 3 is a block diagram of a first embodiment of a touch module, a control module, a switch module, and the host of the on-screen display adjustment system of FIG. 1.

FIG. 4 is a block diagram of a second embodiment of the touch module, the control module, the switch module, and the host of the on-screen display adjustment system of FIG. 1.

FIG. 5 is a flow chart of an embodiment of an on-screen display adjustment method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

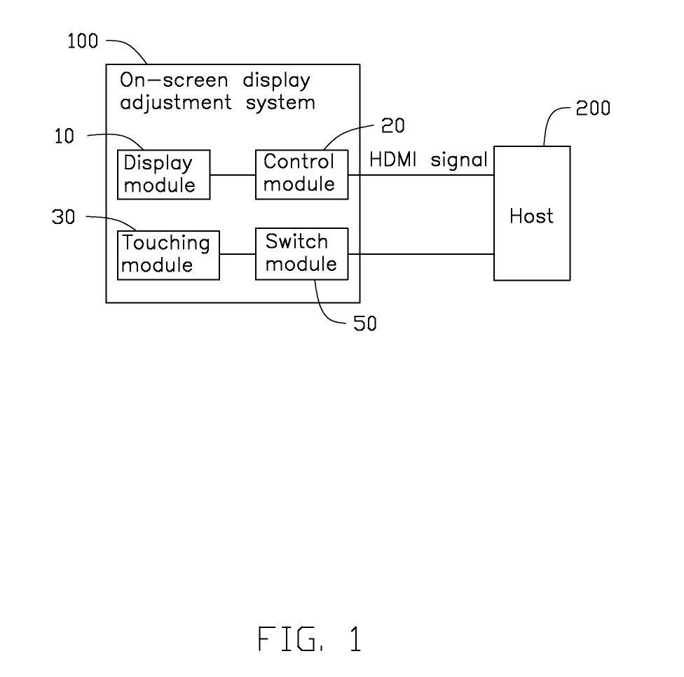

FIG. 1 illustrates an on-screen display (OSD) adjustment system 100 in accordance with an embodiment. The OSD adjustment system 100 can include a display module 10, a control module 20, a touch module 30, and a switch module 50.

The control module 20 is coupled between the display module 10 and a host 200 and configured to convert data to show images on the display module 10.

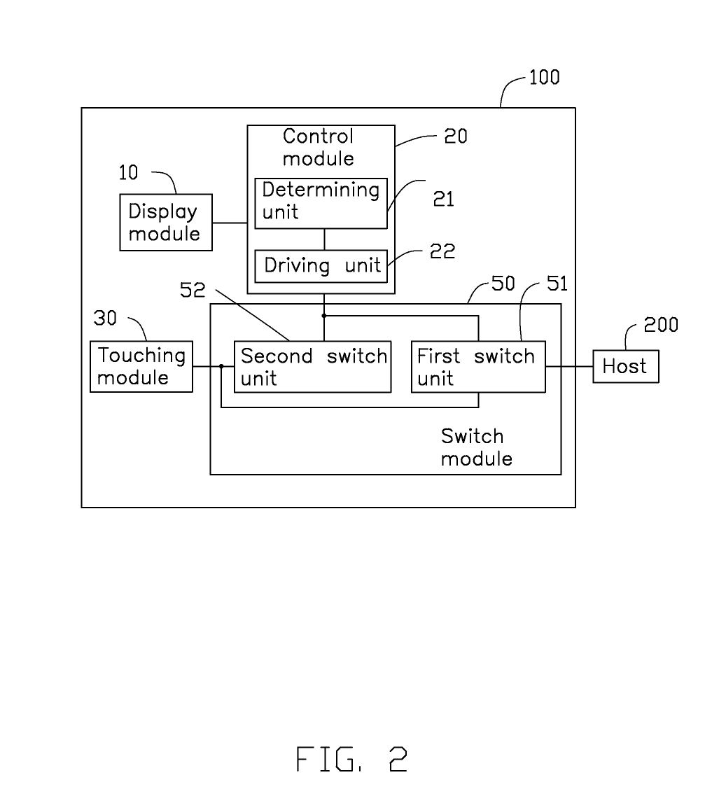

FIG. 2 illustrates that the switch module 50 can include a first switch unit 51 and a second switch unit 52. The first switch unit 51 is coupled between the touch module 30 and the host 200 and configured to couple and decouple the touch module 30 and the host 200. The second switch unit 52 is coupled between the touch module 30 and the control module 20 and configured to couple and decouple the touch module 30 and the control module 20.

The control module 20 further includes a determining unit 21 and a driving unit 22. The determining unit 21 is configured to determine whether access into an OSD adjustment is required and send a determination result to the driving unit 22. The driving unit 22 is coupled to the first switch unit 51 and the second switch unit 52 and configured to send out a driving signal according to the determination result.

When the determination result is that accessing into an OSD adjustment is required, the display module 10 shows an OSD menu window, which shows a plurality of configurable items of a monitor. The driving unit 22 sends out a first driving signal simultaneously, the first driving signal switches off the first switch unit 51 and switches on the second switch unit 52. Thus, the touch module 30 is disconnected from the host 200 and coupled to the control module 20 directly. In this position, the control module 20 can receive operation signals from the touch module 30 and drive the display module 10 to change the configurable items according to the operation signals, and configuration adjustments can be made by touching the touch module 30.

When the determination result reveals no need to access into an OSD adjustment, the driving unit 22 sends out a second driving signal to switch on the first switch unit 51 and switch off the second switch unit 52. Thus, the touch module 30 is disconnected from the control module 20 and coupled to the host 200 directly. In this position, the host 200 can receive operation signals from the touch module 30, and then the control module 20 drives the display module 10 to perform the configuration adjustments according to the operation signals.

In at least one embodiment, the first driving signal is a high level voltage signal, and the second driving signal is a low level voltage signal.

The determining unit 21 determines whether access into the OSD adjustment is required according to a trigger condition. When the trigger condition occurs, the determination result is that access is required. Until the trigger condition occurs, the determination result is that no need exists to access an OSD adjustment. In at least one embodiment, the trigger condition is continuously pressing a power button for a certain time duration or a certain number of times. In at least one embodiment, the certain time duration is two seconds, and the certain number of times is two. The power button is further configured to shut down and open the monitor when pressed for less than the certain time duration or the certain number of times.

Thus, the configurable items can be adjusted by a power button only, there is no need to use other buttons to adjust the configurable items.

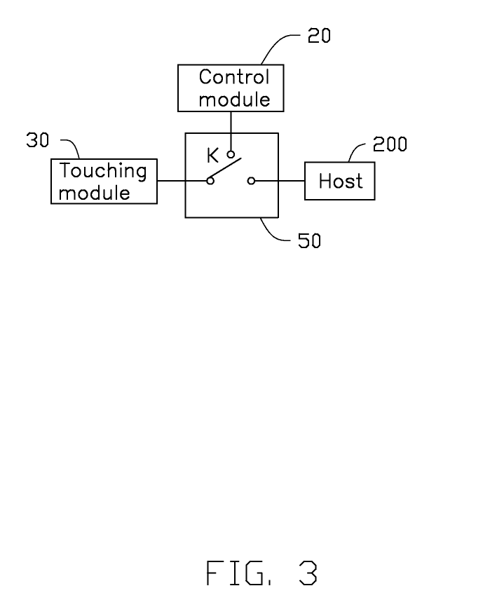

FIG. 3 illustrates that, in a first embodiment, the switch module 50 can be a single-pole double-throw switch K.

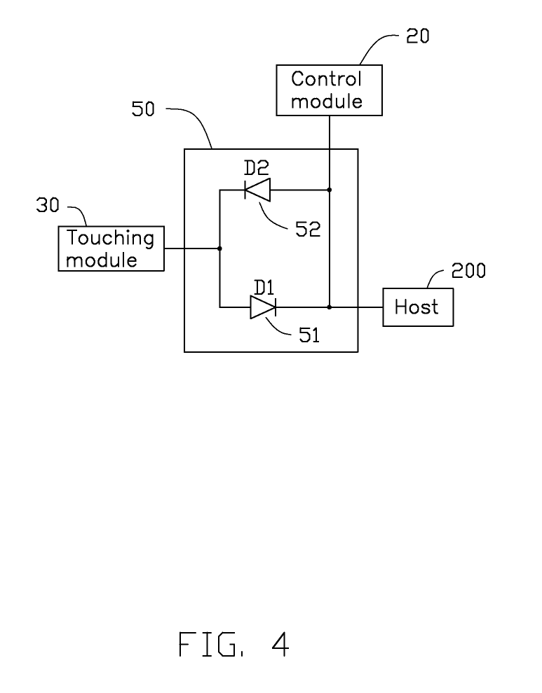

FIG. 4 illustrates that, in a second embodiment, the first switch unit 51 is a first diode D1 and the second switch unit 52 is a second diode D2. The positive pole of the second diode D2 is coupled to the driving unit 22 and the negative pole of the second diode D2 is coupled to the touch module 30. The negative pole of the first diode D1 is coupled to the driving unit 22 and configured to couple to the host 200, and the positive pole of the first diode D1 is coupled to the touch module 30.

In other embodiments, the first switch unit 51 and the second switch unit 52 can be triodes, field-effect tubes, or other switch components with opposing connections.

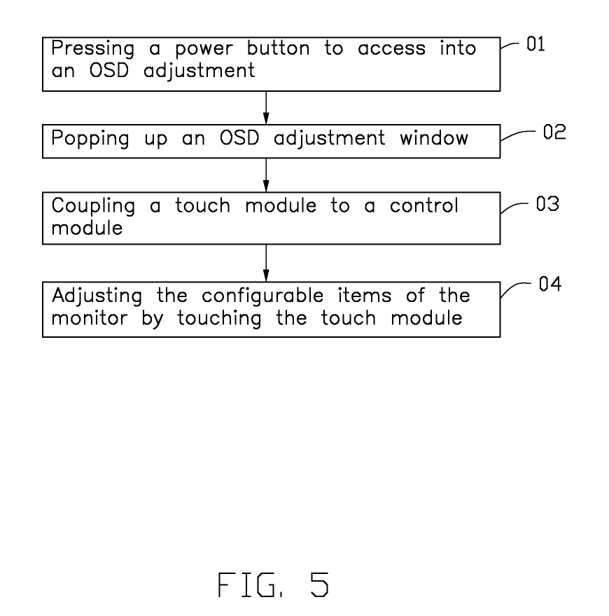

Referring to FIG. 5, a flowchart is presented in accordance with an example embodiment. The example method is provided by way of example, as there are a variety of ways to carry out the method. The method described below can be carried out using the configurations illustrated in FIG. 5, for example, and various elements of these figures are referenced in explaining the example method. Each block shown in FIG. 5 represents one or more processes, methods or subroutines carried out in the example method. Furthermore, the illustrated order of blocks is illustrative only and the order of the blocks can change according to the present disclosure. Additional blocks can be added or fewer blocks may be utilized without departing from this disclosure. The example method can begin at block 01.

At block 01: pressing the power button to access into the OSD adjustment;

At block 02: popping up the OSD adjustment window;

At block 03: coupling the touch module 30 to the control module 20; and

At block 04: adjusting the configurable items of the monitor by touching the touch module 30.

The block 02 and block 03 can be performed simultaneously. The block 01 can include pressing the power button a certain time or a certain times to access into the OSD adjustment. In at least one embodiment, the certain time is two seconds, and the certain times are two times. The OSD adjustment method further includes disconnecting the touch module 30 and the host 200 when coupling the touching module 30 to the control module 20.

The embodiments shown and described above are only examples. Many details are often found in the art such as the other features of an on-screen display adjustment system and method. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An on-screen display (OSD) adjustment system, located in a monitor, comprising:
a display module;
a control module configured to control the display module to display images;
a touch module; and
a switch module comprising a first switch unit coupled between the control module and touch module and a second switch unit coupled between the touch module and a host;
wherein the control module is further configured to determine that an OSD adjustment has been accessed and switch on the first switch unit and switch off the second switch unit in event the OSD adjustment is required, and the touch module is electronically coupled to the control module, such that the control module is capable of receiving an operation signal by touching on the touch module, and the operation signal is configured to adjust configurable items of the monitor.

2. The OSD adjustment system of claim 1, further comprising a power button, wherein the power button is configured to be pressed to access into the OSD adjustment.

3. The OSD adjustment system of claim 2, wherein the power button is further configured to be pressed to shut down/open the monitor, and the power button is capable of being pressed for different times or different time to access into the OSD adjustment and shut down/open the monitor.

4. The OSD adjustment system of claim 1, wherein the control module comprises a determining unit and a driving unit, the determining unit is configured to determine whether access into the OSD adjustment and send a determining result to the driving unit, the driving unit is coupled to the first switch unit and the second switch unit and configured to send out a driving signal according to the determining result, and the driving signal is configured to switch on and off the first switch unit and the second switch unit.

5. The OSD adjustment system of claim 4, wherein the determining unit is configured to determine whether access into the OSD adjustment according to a trigger condition, when the trigger condition occurs, the driving unit sends out a first driving signal to switch off the first switch unit and switch on the second switch unit, and until trigger condition occurs, the driving unit sends out a second driving signal to switch on the first switch unit and switch off the second switch unit.

6. The OSD adjustment system of claim 5, wherein the first driving signal is a high level voltage signal, and the second driving signal is a low level voltage signal.

7. The OSD adjustment system of claim 1, wherein the switch module is a single-pole double-throw switch.

8. The OSD adjustment system of claim 1, wherein the first switch unit is a first diode, the positive pole of the second diode is coupled to the driving unit, the negative pole of the second diode is coupled to the touch module.

9. The OSD adjustment system of claim 8, wherein the second switch unit is a second diode, the negative pole of the first diode is coupled to the driving unit and configured to couple to the host, and the positive pole of the first diode is coupled to the touch module.

10. An on-screen display (OSD) adjustment system, located in a monitor, comprising:
a display module;
a control module configured to control the display module to display images;
a touch module;
a power button configured to be pressed to drive the monitor into an OSD adjustment; and
a switch module comprising a first switch unit coupled between the control module and touch module and a second switch unit coupled between the touch module and a host;
wherein the control module is further configured to determine that the power button has been pressed and switch on the first switch unit and switch off the second switch unit in event the power button is pressed, the touch module is electronically coupled to the control module, such that the control module is capable of receiving an operation signal by touching on the touch module, and the operation signal is configured to adjust configurable items of the monitor.

11. The OSD adjustment system of claim 10, wherein the power button is further configured to be pressed to shut down/open the monitor, and the power button is capable of being pressed for different times or different time to access into the OSD adjustment and shut down/open the monitor.

12. The OSD adjustment system of claim 10, wherein the control module comprises a determining unit and a driving unit, the determining unit is configured to whether the power button is pressed and send a determining result to the driving unit, the driving unit is coupled to the first switch unit and the second switch unit and configured to send out a driving signal according to the determining result, and the driving signal is configured to switch on and off the first switch unit and the second switch unit.

13. The OSD adjustment system of claim 12, wherein when the power button is pressed, the driving unit sends out a first driving signal to switch off the first switch unit and switch on the second switch unit, and until the power button is pressed, the driving unit sends out a second driving signal to switch on the first switch unit and switch off the second switch unit.

14. The OSD adjustment system of claim 13, wherein the first driving signal is a high level voltage signal, and the second driving signal is a low level voltage signal.

15. The OSD adjustment system of claim 10, wherein the switch module is a single-pole double-throw switch.

16. The OSD adjustment system of claim 10, wherein the first switch unit is a first diode, the positive pole of the second diode is coupled to the driving unit, the negative pole of the second diode is coupled to the touch module.

17. The OSD adjustment system of claim 16, wherein the second switch unit is a second diode, the negative pole of the first diode is coupled to the driving unit and configured to couple to the host, and the positive pole of the first diode is coupled to the touch module.

18. An on-screen display (OSD) adjustment method comprising:
pressing a power button to access into an OSD adjustment;
popping up an OSD menu adjustment window;
coupling a touch module to a control module; and
adjusting configurable items of a monitor by touching on the touch module in the OSD menu adjustment window via the control module.

19. The OSD adjustment method of claim 18, wherein the OSD adjustment is pressed into by pressing the power button continuously.

20. The OSD adjustment method of claim 18, further comprising disconnecting the touch module and a host when coupling the touch module to the control module.
